(19) United States
(12) Patent Application Publication
(10) Pub. No.: US 2019/0232172 A1
(43) Pub. Date: Aug. 1, 2019

(54) CHAIN OF CUSTODY IN GAMING PLATFORMS

(71) Applicant: Roblox Corporation, San Mateo, CA (US)

(72) Inventor: Arthur Remy Malan, Menlo Park, CA (US)

(21) Appl. No.: 15/883,447

(22) Filed: Jan. 30, 2018

(51) Int. Cl. A63F 13/792; G06Q 20/22; A63F 13/77; G06Q 20/38; G06Q 20/40; H04L 9/06

(52) U.S. Cl. CPC A63F 13/792; G06Q 20/29; H04L 9/0637; G06Q 20/3827; G06Q 20/401; A63F 13/77

(57) ABSTRACT

A method and system is disclosed performs transactions of a virtual game item that transfer the virtual game item between user accounts of a gaming platform. The method and system generate entries in a ledger to record the transactions of the virtual game item. The entries are linked to a preceding entry using one or more hash values. The method and system receive a claim from a first user account of the user accounts to dispute a first transaction of the transactions. Responsive to the claim, the method and system perform an account restore operation based on the ledger that retrieves the virtual game item from another user account identified as a last entry in the ledger and restores the virtual game item to the first user account.

### TECHNICAL FIELD

This disclosure relates to the field of gaming platforms and, in particular, to generating a chain of custody for a virtual game item using a cryptographically secure ledger and performing an account restore operation based on the cryptographically secure ledger.

### BACKGROUND

Collaboration platforms allow users to connect to and share information with each other via the Internet. Users of a collaboration platform, such as a gaming platform, may participate in multi-user gaming environments, design custom gaming environments, decorate avatars, or exchange virtual items with other users, and so forth.

### DESCRIPTION OF DRAWINGS

Various implementations of the disclosure will be understood more fully from the detailed description given below and from the accompanying drawings of various implementations of the disclosure.

FIG. 1 illustrates an example system architecture, in accordance with implementations of the disclosure.

FIG. 2 illustrates a secure ledger used in a collaboration platform, in accordance with implementations of the disclosure.

FIG. 3 is a flow diagram illustrating method for creating a secure ledger and use of the ledger in a collaboration platform, in accordance with implementations of the disclosure.

FIG. 4 is a block diagram illustrating an exemplary computer system, in accordance with implementations of the disclosure.

### DETAILED DESCRIPTION

Collaboration platforms, such as gaming platforms, offer a variety of ways for users to interact with one another. For example, users of a gaming platform may work together towards a common goal, share various virtual gaming items, send electronic messages to one another, and so forth. Users of a collaboration platform may play games (e.g., playing users) with characters or create games (e.g., creating users) with developmental tools via the collaboration platform. In a collaboration platform, users may transact (e.g., buy, sell, or trade) virtual game items (e.g., a virtual tool for use in a virtual gaming environment) with other users of the collaboration platform as part of gameplay or otherwise.

Transactions of virtual game items performed on a collaboration platform between users may have particular challenges. For example, a gaming platform may be a low-trust environment. User accounts may be created with little to no verification or authentication (e.g., the user accounts may not be verified by a telephone number or email address). The identity of users may unknown, and users may interact with one another on the gaming platform anonymously. Transactions of virtual game items in the low-trust environment may be based on “hand shake” agreements, rather than be validated of facilitated by a third party (e.g., held in escrow until the transaction is validated). In such types of transactions, one user may promise to trade with another user a virtual game item in exchange for another virtual game item, for example. If one party (e.g., offending party) does not deliver on the promise, the injured party may dispute the transaction and ask for damages (e.g., ask for the return of the transferred virtual game item). Without a record of the transactions of virtual game items, the gaming platform may not be able to return the disputed virtual game item and make the injured party whole. In some situations, the offending party may further attempt to obfuscate the disputed virtual game item. For example, the offending party may “launder” the disputed virtual game item through multiple “shell” user accounts of the gaming platform making recovery of the virtual game item particularly challenging. In another example, the offending party may act maliciously and destroy or delete the virtual game item from the gaming platform.

In some cases, a record of the transactions of virtual game items may be used to determine a transaction history of a virtual game item and return a virtual game item to an injured party. However, a record of transactions of virtual game items has additional challenges. For example, a record of transactions may be incomplete and unable to effectively trace the transaction history of a virtual game item. In another example, a record of transactions may be manipulated by one or more “bad actors” so that the authority of the record of transactions is compromised. A compromised record of transactions cannot be used as a definitive source or truth, and as such is unreliable to remedy a disputed transaction.

Aspects of the disclosure address the above-mentioned and other challenges by creating a secure chain of custody of a virtual game item in a gaming platform by generating entries in secure ledger that records the transactions of the virtual game item between user accounts in the gaming platform. Chain of custody may refer to a chronological record of custody, control, and transfer of an item. A chain of custody may be implemented using a ledger. A ledger may refer to a secure electronic record of transactions of one or more items, such as virtual game items, where each successive entry of the ledger is linked to a preceding entry using a hash value.

In some implementations, each entry of the ledger may be associated with a particular transaction of the virtual game item. An entry of the ledger may include transaction data that is indicative of or specific to the particular transaction of a virtual game item. The transaction data may be used as input to a hashing function to generate a hash value for the particular entry.

In a subsequent transaction of the virtual game item, a new entry in the ledger may be created that is linked with the immediately preceding entry. For example, the transaction data of the new entry may include a hash value that depends on the hash values of all preceding entries. The transaction data of the new entry that depends on the hash value of all preceding entries may be used as an input to the same hashing function to generate a hash value for the new entry. By linking each successive entry of the ledger using a hash value of a preceding entry, the ability to manipulate the entries in the ledger becomes difficult, if not effectively impossible.

In some implementations, where one party (e.g., offending party) does not deliver on a promise associated with a transaction of a virtual game item, the injured party may dispute the transaction by submitting a claim to dispute the transaction with the offending party. A validation operation(s) may be performed, using the secure ledger, to determine the legitimacy of claim by the injured party. In some implementations where the claim is determined to be valid, an account restore operation may be performed to restore the user account disputing the transaction to a state that appears as if the disputed transaction had never occurred.

Accordingly, aspects of the disclosure generate an authoritative chain of custody for a virtual game item and perform account restore operations that return a disputed virtual game item to an injured party. Generating an authoritative chain of custody of a virtual game item in a gaming platform using a secure ledger addresses security challenges of electronic records in a collaboration platform, such as a gaming platform. In particular, the aforementioned addresses security challenges of electronic records for transactions of virtual game items in a gaming platform. Generating an authoritative chain of custody of a virtual game item improves the technological process of generating a record of transactions for virtual game items by generating a secure ledger protected against tampering by malicious entities. The secure ledger also improves operation of a computer or computer network by reducing or eliminating additional security measures used to protect ledger from tampering. Additionally, the secure ledger recording the transactions of virtual game items may be used to restore user accounts affected by improper transactions. Using the secure ledger improves the technical process of restoring accounts at least because using a secure ledger reduces the operations in determining whether to return the virtual game item to the injured party (e.g., reduces additional audit operations to verify the authenticity of the ledger), and expedites the process of locating the disputed virtual game item in the collaboration platform and returning the disputed virtual game item to the injured party. Additionally, using the secure ledger to perform account restore operations improves the operation of a computer or computer network by reducing the computation (e.g., processing) resources used to determine whether to return the virtual game item to the injured party and to locate the disputed virtual game item.

It may be noted that a collaboration platform described as a gaming platform herein is provided for purposes of illustration, rather than limitation. A collaboration platform may be one or more of numerous platforms, such as a gaming platform, a social networking platform, purchasing platform, a messaging platform, creation platform, and so forth. It may be further noted that aspects of the disclosure are illustrated using an example of a gaming platform and games for purposes of illustration, rather than limitation.

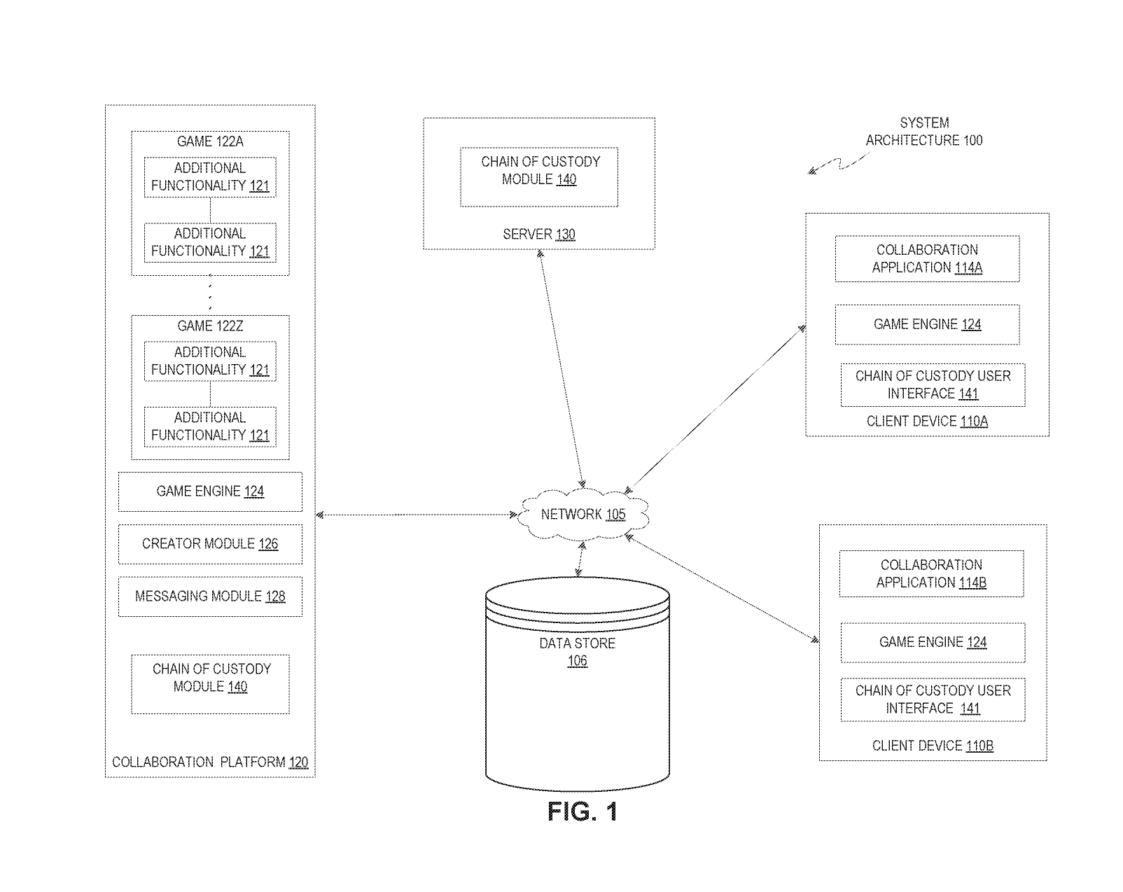

FIG. 1 illustrates an example system architecture 100, in accordance with one implementation of the disclosure. The system architecture 100 (also referred to as “system” herein) includes client devices 110A and 110B (generally referred to as “client device(s) 110” herein), a network 105, a data store 106, a collaboration platform 120, and a server 130.

In one implementation, network 105 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, and/or a combination thereof.

In one implementation, the data store 106 may be a memory (e.g., random access memory), a cache, a drive (e.g., a hard drive), a flash drive, a database system, or another type of component or device capable of storing data. The data store 106 may also include multiple storage components (e.g., multiple drives or multiple databases) that may also span multiple computing devices (e.g., multiple server computers).

In implementations, the server 130 may be one or more computing devices (e.g., a rackmount server, a server computer, etc.). In implementations, the server 130 may be included in the collaboration platform 120, be an independent system, or be part of another system or platform. The server 130 may include chain of custody module 140.

In some implementations, the collaboration platform 120 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to collaboration platform 120. The collaboration platform 120 may also include a website (e.g., a webpage) or application back-end software that may be used to provide a user with access to content provided by collaboration platform 120. For example, users may access collaboration platform 120 using collaboration application 114 on client devices 110. It may be noted that collaboration application 114A and 114B may generally referred to as collaboration application(s) 114. In some implementations, collaboration application 114 may be two instances of the same application.

In implementations, collaboration platform 120 may be a type of social network providing connections between users. In implementations of the disclosure, a “user” may be represented as a single individual. However, other implementations of the disclosure encompass a “user” being an entity controlled by a set of users and/or an automated source. For example, a set of individual users federated as a community in a social network may be considered a “user.”

In one implementation, collaboration platform 120 may be a gaming platform, such as an online gaming platform or virtual gaming platform. For example, the gaming platform may provide single-player or multi-player games to a community of users that may access or interact with the games 122A-122Z using client devices 110 via network 105. In implementations, games 122 (also referred to as “video game,” “online game,” or “virtual game” herein) may be two-dimensional (2D) games, three-dimensional (3D) games, virtual reality (VR) games, or augmented reality (AR) games, for example. In implementations, a game 122 may be played in real-time with other users of the game 122.

In some implementations, a game 122 can include an electronic file that can be executed or loaded using software, firmware or hardware configured to present the game content (e.g., digital media item) to an entity. In some implementations, a game 122 may be executed by a game engine 124 to generate a gaming video including multiple frames and audio. The gaming video may be generated (e.g., rendered) by the game engine 124 based on commands or user input. In some implementations, a game engine 124 (e.g., a rendering engine of the game engine 124) receives user input and generates a gaming video based on the user input. In some implementations, a game engine 124 (either local to the client device 110 or at collaboration platform 120) receives user input and generates commands (e.g., rendering commands, graphics library commands, etc.) based on the user input. In some implementations, a game engine 124 (e.g., a rendering engine of the game engine 124) receives from collaboration platform 120 the generated commands and generates the gaming video based on the generated commands. The gaming video may be displayed via a user interface of a client device 110.

In some implementations, collaboration platform 120 hosts games 122 and allows users to interact with the games 122 using collaboration application 114 of client devices 110. Users of collaboration platform 120 may play, create, interact with, or build games 122, or create and build objects (e.g., also referred to as “item(s)” or “game objects” or “virtual game item(s)” herein) of games 122. For example, in generating user-generated virtual items, users may create characters, decoration for the characters, one or more virtual environments for an interactive game, or build structures used in a game 122, among others. In implementations, users may buy, sell, or trade game virtual game objects, such as in-platform currency (e.g., virtual currency), with other users of the collaboration platform 120. In implementations, collaboration platform may transmit game content to collaboration applications 114. Game content (also referred to as “content” herein) may refer to any data or software instructions (e.g., game objects, game, user information, video, images, commands, media item, etc.) associated with collaboration platform 120 or collaboration applications 114.

It may be noted that collaboration platform 120 hosting games 122, is provided for purposes of illustration, rather than limitation. In some implementations, collaboration platform 120 may host one or more media items. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In implementations, a media item may be an electronic file that can be executed or loaded using software, firmware or hardware configured to present the digital media item to an entity.

In one implementation, collaboration platform 120 may consolidate the game content from the client devices 110 and transmit the consolidated game content (e.g., gaming video, rendering commands, user input, graphics library commands, etc.) to each of the client devices 110 to display interactions of the multiple users in a multi-player gaming environment. In another implementation, collaboration platform 120 may transmit the game content from one or more client devices 110 to another client device for the other client device to consolidate and display the game content. In another implementation, the collaboration platform 120 may receive the game content (e.g., first user transmitting user input via client device 110A and second user transmitting user input via client device 110B), generate game results (e.g., first user beats second user), and transmit the game results to the client devices 110.

In some implementations, a game 122 may be associated with a particular user or particular group of users (e.g., a private game), or made widely available to users of the collaboration platform 120 (e.g., a public game). In implementations, where collaboration platform 120 associates one or more games 122 with a specific user or group of users, collaboration platform 120 may associated the specific user(s) with a game 122 using user account information (e.g., a user account identifier such as username and password).

In some implementations, collaboration platform 120 may include a game engine 124. In implementations, game engine 124 may be used for the development or execution of games 122. For example, game engine 124 may include a rendering engine (“renderer”) for 2D, 3D, VR, or AR graphics, a physics engine or collision detection (and collision response), sound, scripting, animation, artificial intelligence, networking, streaming, memory management, threading, localization support, scene graph, or video support for cinematics, among other features. In some implementations, an instance of game engine 124 may be included on client devices 110. In some implementations, game engine 124 of client devices 110 may work independently, in collaboration with game engine 124 of collaboration platform 120, or a combination of both.

In implementations, collaboration platform 120 may include a creator module 126. In implementations, creator module 126 may allow users to become creators to design or create environments in an existing game 122 or create new games or create new game objects within games or environments. In some implementations, a game 122 may have a common set of rules or common goal, and the environments of a game 122 share the common set of rules or common goal. In implementations, different games may have different rules or goals from one another. In some implementations, games may have one or more environments (also referred to as “gaming environments” or “virtual environment” herein) where multiple environments may be linked. For example, a user may build a virtual environment that is linked to another virtual environment created by another user. A character of the virtual game may cross the virtual border to enter the adjacent virtual environment. In implementations, game objects (e.g., also referred to as “item(s)” or “objects” or “virtual game item(s)” herein) may refer to objects that are used, created, shared or otherwise depicted in games 122 of the collaboration platform 120. For example, game objects may include a part, model, character, tools, weapons, clothing, buildings, vehicles, currency, flora, fauna, components of the aforementioned (e.g., windows of a building), and so forth.

In implementations, creator module 126 may allow a user to create, modify, or customize characters. In implementations, characters (or game objects generally) are constructed from components, one or more of which may be selected by the user, that automatically join together to aid the user in editing. One or more characters (also referred to as an “avatar” or “model” herein) may be associated with a user (also referred to as a “playing user” herein) where the user may control the character to facilitate a user's interaction with the game 122. In implementations, a character may include components such as body parts (e.g., hair, arms, legs, etc.) and accessories (e.g., t-shirt, glasses, decorative images, tools, etc.). In implementations, body parts of characters that are customizable include head type, body part types (arms, legs, torso, and hands), face types, hair types, and skin types, among others. In implementations, the accessories that are customizable include clothing (e.g., shirts, pants, hats, shoes, glasses, etc.), weapons, or other tools. In implementations, the user may also control the scale (e.g., height, width, or depth) of a character or the scale of components of a character. In implementations, the user may control the proportions of a character (e.g., blocky, anatomical, etc.).

In some implementations, a component, such as a body part, may be a primitive geometrical shape such as a block, a cylinder, a sphere, etc., or some other primitive shape such as a wedge, a torus, a tube, a channel, etc. In implementations, creator module 126 may publish a user's character for view or use by other users of collaboration platform 120. It some implementations, creating, modifying, or customizing characters, other game objects, games 122, or game environments may be performed by a user using a user interface (e.g., developer interface) and with or without scripting (or without an application programming interface (API)). It may be noted that for purposes of illustration, rather than limitation, characters are described as having a humanoid form. In may further be noted that characters may have any form such as a vehicle, animal, inanimate object, or other creative form.

In implementations, collaboration platform 120 may store characters created by users in data store 106. In implementations, the collaboration platform 120 maintains a character catalog and game catalog that may be presented to users via collaboration application 114. A user may select a game 122 from the game catalog to play. In implementations, the game catalog includes images of games stored on collaboration platform 120. In addition, a user may select a character (created by the playing user or other user) from the character catalog to participate in the chosen game. The character catalog includes images of characters stored on the collaboration platform 120. In implementations, one or more of the characters in the character catalog may have been created or customized by the user. In implementations, the chosen character may have character settings defining one or more of the components of the character.

In implementations, a user's character includes a configuration of components, where the configuration and appearance of components and more generally the appearance of the character may be defined by character settings. In implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by collaboration platform 120.

In implementations, creator module 126 includes a unique personal build and publishing service for creating and administering games 122 and gaming environments on the Internet that allows users (also referred to as “creating users,” “creators,” “owners,” or “owning users” herein) to create, own, or administrate games 122 and gaming environments using cloud-mediated computational resources, for example. In implementations, creator module 126 may use a user interface (also referred a “developer interface” herein) via collaboration application 114 to allow users access the functionality of creator module 126. In implementations, the developer interface may be part of collaboration application 114. For example, a developer interface of collaboration application 114 may allow a user access to a library of game objects that may be selected by the user to build a game environment or place game objects within a game 122 or environment. The user may publish their selected game objects via the developer interface so that the game objects are available to playing users of the game 122 or environment.

In implementations, collaboration platform 120 executing creator module 126 includes a user-interfacing website or application (e.g., collaboration application 114) where users may access online computational resources hosted by collaboration platform 120 for the purposes of building, administrating, editing, and interacting with personally owned games 122 or gaming environments. In implementations, creator module 126 includes tools available to users for creating and instantiating three-dimensional virtual games or environments. In implementations, creator module 126 is available to users that wish to create and administer their own private virtual game 122. In implementations, a user may access creator module 126 using collaboration application 114.

In implementations, creator module 126 may provide control of created games 122 and environments to owning users who may set administrative policy regarding who will be allowed to interact with the created game 122 or environment and who has the capability of modifying, editing, or interacting with the game 122 or environment. Users with administrative control may also be referred to as owning users herein, unless otherwise specified. In some implementations, administrative rules can be granular to the point of specifying various levels of interaction, modification, or editing capabilities for certain individuals who might be recruited or otherwise desire to interact with the game 122 or gaming environment. For example, individuals may be recruited from friends in collaboration platform 120 or friends from social networks or in other collaborative or group associated online venues. In implementations, creator module 126 has administrative tools for setting such policies including or in addition to general rules for interaction within the game 122 or gaming environment.

In implementations, the client devices 110A through 110B may each include computing devices such as personal computers (PCs), mobile devices (e.g., laptops, mobile phones, smart phones, tablet computers, or netbook computers), network-connected televisions, gaming consoles, etc. In some implementations, client devices 110A through 110B may also be referred to as “user devices.” In implementations, one or more client devices 110 via collaboration application 114 may connect to collaboration platform 120 at any given moment.

In implementations, each client device 110 may include an instance of collaboration application 114. In one implementation, the collaboration application 114 may be an application that allows users to use and interact with collaboration platform 120, such as control a virtual character in a virtual game hosted by collaboration platform 120, or view or upload content, such as images, video items, web pages, documents, and so forth. In one example, the collaboration application 114 may be a web application (e.g., an application that operates in conjunction with a web browser) that can access, retrieve, present, and/or navigate content (e.g., virtual character in a virtual environment, etc.) served by a web server. In another example, collaboration application 114 may be a native application. The collaboration application 114 may render, display, and/or present the content (e.g., a web page, a media viewer) to a user. In an implementation, the collaboration application 114 may also include an embedded media player (e.g., a Flash® player) that is embedded in a web page. In another example, the collaboration application 114 may be a standalone application (e.g., a mobile application, app, or a gaming program) that allows users to interact with collaboration platform 120. According to aspects of the disclosure, the collaboration application 114 may be a collaboration platform application for users to build, create, edit, upload content to the collaboration platform 120 as well as interact with collaboration platform 120. As such, the collaboration applications 114 may be provided to the client devices 110A and 110B by the server 130 or collaboration platform 120. In another example, the collaboration applications 114 may be applications that are downloaded from the server 130. In some implementations, collaboration application 114 of client device 110 may include game engine 124. In some implementations, game engine 124 of client device 110 may be separate from collaboration application 114A.

In implementations, a user may login to collaboration platform 120 via collaboration application 114. The user may access a user account by providing user account information (e.g., username and password) where the user account is associated with one or more characters available to participate in one or more games 122 of collaboration platform 120.

In general, functions described in one implementation as being performed by the collaboration platform 120 can also be performed on the client devices 110A through 110B, or server 130, in other implementations if appropriate. In addition, the functionality attributed to a particular component can be performed by different or multiple components operating together. The collaboration platform 120 can also be accessed as a service provided to other systems or devices through appropriate application programming interfaces, and thus is not limited to use in websites.

In implementations, collaboration platform 120 may include messaging module 128. In implementations, messaging module 128 may be a system, application, or module that allows users to exchange electronic messages via a communication system, such as network 105. Messaging module 128 may be associated with collaboration application 114 (e.g., module of collaboration application 114 or be a separate application). In implementations, users may interface with messaging module 128 and exchange electronic messages among users of collaboration platform 120. Messaging module 128 may be, for example, an instant messaging application, a text messaging application, an email application, a voice messaging application, a video messaging application, or a combination of multiple applications, among others.

In implementations, messaging module 128 may facilitate the exchange of electronic messages between users. For example, a user may be logged into a messaging application on client device 110A, and another user may be logged into a messaging application on client device 110B. The two users may start a conversation, such as an instant messaging conversation. Messaging module 128 may help facilitate the messaging conversation by sending and receiving the electronic messages between the users of collaboration platform 120.

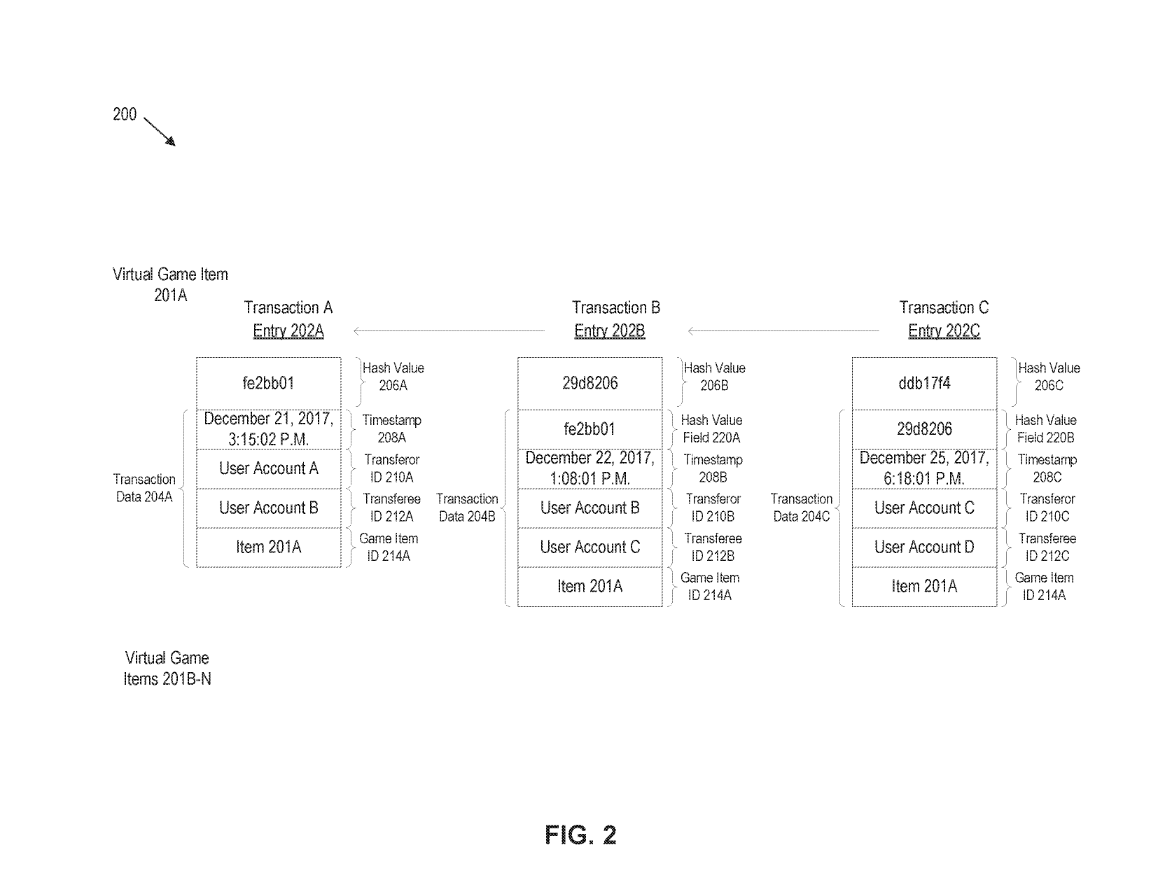

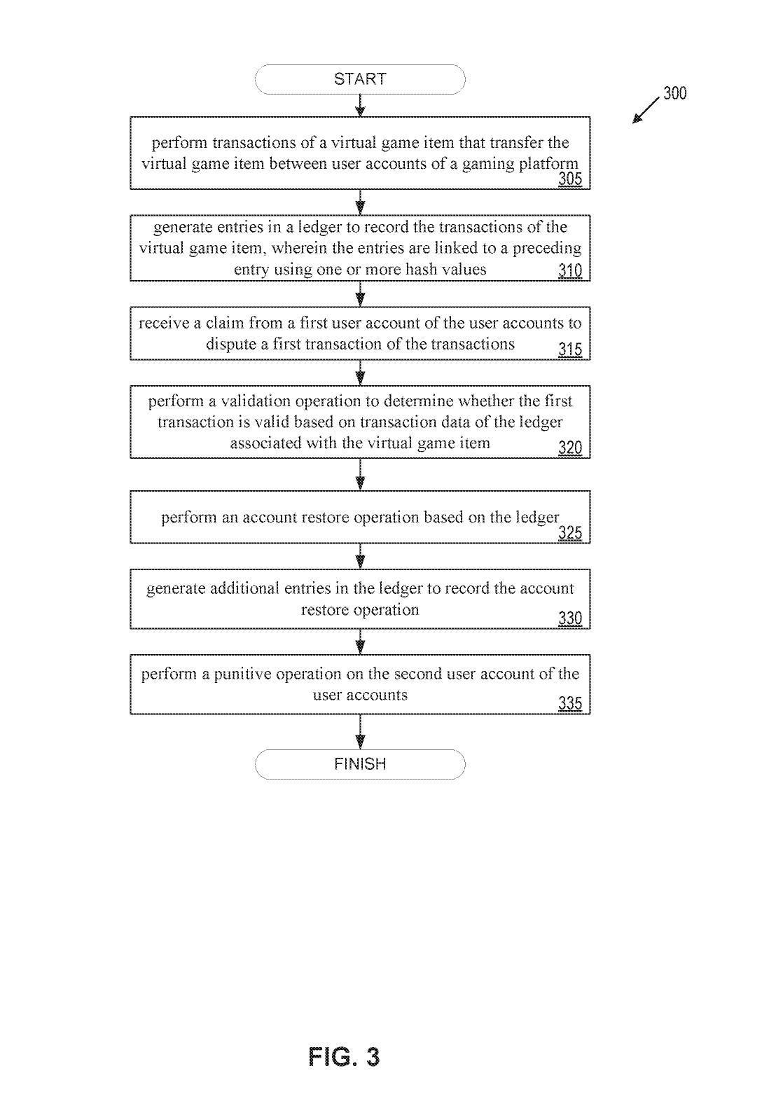

For the sake of illustration, rather than limitation, chain of custody module 140 is described as implemented on collaboration platform 120. In other implementations, chain of custody module 140 may in part or wholly be implemented on client device 110. In other implementations, chain of custody module 140 may in part or wholly be implemented on server 130. In other implementations, chain of custody module 140 operating on one or more of client device 110, server 130, or collaboration platform 120 may work in conjunction to perform the operations described herein. Although implementations of the disclosure are discussed in terms of collaboration platforms, implementations may also be generally applied to any type of social network providing connections between users. The chain of custody module 140 may help facilitate the operation described herein, such as operation described with respect to FIG. 2 and FIG. 3. For example, the chain of custody module 140 may help facilitate transactions of virtual game items, record the transactions in a ledger, and perform account restore operations.

In implementations, chain of custody user interface 141 may allow a user to interface with chain of custody module 140 of collaboration platform 120. In implementations, chain of custody user interface 141 of client devices 110 may be a separate application or part of collaboration application 114 (e.g., add-in). The chain of custody user interface 141 may allow users of the collaboration platform 120 to view the chain of custody of one or more virtual game items. In some implementations, users using the chain of custody user interface 141 may be able to view the chain of custody (e.g. ledger) but may not be able to directly modify or change or edit the ledger.

In situations in which the systems discussed here collect personal information about users, or may make use of personal information, the users may be provided with an opportunity to control whether the collaboration platform 120 collects user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the collaboration platform 120.

FIG. 2 illustrates a ledger used in a collaboration platform, in accordance with implementations of the disclosure. In implementations, ledger 200 may be part of collaboration platform 120 and stored on data store 106. In implementations, chain of custody module 140 of collaboration platform 120 may generate ledger 200 and the contents therein. In some implementations, contents of the ledger 200 may be made available to users for viewing via chain of custody user interface 141 of client device 110. It may be noted that elements of FIG. 1 may be used to help describe FIG. 2.

In some implementations, the chain of custody of one or more virtual game item is recorded in ledger 200. Virtual game items may include characters, character decorations (e.g., hats, shirts), and so forth. In some implementations, the virtual game items may be user-generated virtual items. In some implementations, the virtual game item may be non-user-generated virtual items. In some implementations, ledger 200 may implement block chain techniques to add a level of security to the ledger 200, which prevents fraudulent manipulation of the ledger by bad actors and creates an authoritative source of truth for transactions of virtual game items. As an authoritative source of truth, ledger 200 may be used to record and track the transaction history of virtual game items in the collaboration platform 120, as well as to determine the validity of claims that dispute transactions and to remedy disputed transactions.

For example, ledger 200 may be used to “roll-back” a fraudulent transaction by validating a claim of a disputed transaction and identifying a current location of the transacted virtual game item The ledger 200 may be used by chain of custody module 140 to help return the virtual game item to the user account of the injured party (e.g., user account of transferor of the disputed transaction) and restore the one or more affected user accounts (e.g., the user account of the transferor of the disputed transaction, the user account where the virtual game item is currently located, and any affected intermediary user accounts through which the virtual game item was transacted between the user account of the transferor and the user account where the virtual game item is currently located) to a state that appears as if the fraudulent transaction had never occurred.

Ledger 200 shows several entries 202A-202C (generally referred to as “entry 202” or “entries 202” herein) associated with virtual game item 201A. Each entry 202 represents a transaction of virtual game item 201A. For purposes of illustration, rather than limitation, ledger 200 shows three entries 202 associated with virtual game item 201A. It may be noted the any number of entries may exist for a particular virtual game item. It may be further noted that ledger may include entries for one or more virtual game items (e.g., virtual game items 201B through 201N).

In some implementations, the entries 202 of ledger 200 may be ordered chronologically. For example, transaction A associated with entry 202A may be the first transaction of virtual game item 201A (e.g., genesis). Transaction B associated with entry 202B may be the second transaction of virtual game item 201B and occur after transaction A. Transaction C associated with entry 202C may be the third transaction of virtual game item 201C and occur after transaction B.

In some implementations, each entry 202 of the ledger may be associated with transaction data 204. Transaction data 204 includes data that is indicative of or specific to the particular transaction of a virtual game item. In implementations, the data of transaction data 204 includes various fields, each of which may include a value specific to the particular transaction.

For example, transaction data 204A includes the fields of timestamp 208A, transferor identifier 210A, transferee identifier 212A, and virtual game identifier 214A. The field timestamp 208 may be indicative of the time and date of a transaction of virtual game item 201A. Timestamp 208A has a value of Dec. 21, 2017 at 3:15:02 P.M. The field transferor identifier 210 may be indicative of the party (e.g., user account) that initiated the transfer of the virtual game item 201A. Transferor identifier 210A has a value indicating the transferor is user account A. The field transferee identifier 212 may be indicative of the party (e.g., user account) to which the transferor transferred the virtual game item 201A. Transferee identifier 212A has a value indicating the transferee is user account B. The field virtual game identifier 214 may be indicative of the virtual game item that was transferred in a transaction. Virtual game identifier 214A has a value indicative of virtual game item 201A. In some implementations, the virtual game item 201A may have a unique identifier that uniquely identifies the virtual game item from other virtual game items of collaboration platform 120. It may be noted that in other implementations, transaction data 204 may include the same or different fields.

In implementations, each entry 202 may include a hash value 206 (hash value 206A-C are generally referred to as “hash value(s) 206” herein). A hash value 206 of each entry may be unique to each entry and uniquely identify each entry. In implementations, hash values may be generated using input that includes one or more values of the associated transaction data 204. For example, hash value 206A (“fe2bb01”) of entry 202A may be a hash value generated using one or more of the values illustrated in the fields of timestamp 208A, transferor identifier 210A, transferee identifier 212A, or virtual game identifier 214A.

In implementations, each entry 202 subsequent the first entry (e.g., entry 202A) is linked to the immediately preceding entry 202 (e.g., chronologically preceding transaction). For example, entry 202B of transaction B is linked to entry 202A of transaction A, and entry 202C of transaction C is linked to entry 202B of transaction B, as illustrated by the arrows in FIG. 2. The entries 202 are linked to one another in a chain-like fashion by using the hash value 206 of the preceding entry in the calculation of the of the hash value 206 of the current entry 202. For example, transaction data 204B of entry 202B includes an additional field, hash value 220A. The value of the field hash value 220A is the hash value 206A (“fe2bb01”) of the preceding entry 202A. Hash value 206B of entry 202B may be calculated using the hash value of the preceding entry 202A (e.g., “fe2bb01”) and one or more additional values of transaction data 204B.

In implementations, using the hash value of the preceding entry to calculate the hash value of the current entry guarantees within technological or temporal limitations that the entries 202 of the ledger 200 are tamper-proof. If any part of the transaction data 204 (e.g., transaction data 204 used to calculate the hash value 206 of an entry) changes, so does the hash value 206 of the entry 202 to which the hash value 206 is associated, as well as any hash values 206 of subsequent entries 202. Tampering may be determined by comparing the original hash value 206 with the hash values of a tampered ledger 200.

In implementations, the last entry (e.g., entry 202C) of the ledger 200 represents the current state of the virtual game item 201A. The last entry of the ledger 200 may be used to determine the current location (e.g., user account) of the virtual game item 201A. For example, if transaction C is the last transaction of virtual game item 201A, entry 202C indicates that the virtual game item 201A may be found in user account D (e.g., value of transferee identifier 212).

In some implementations, hash value 206 may be an output of a hashing function or algorithm that uses one or more of values of transaction data 204 as input to the hash function. In some implementations, hashing may include taking an input string of any length and processing the input string in a hashing algorithm (e.g., Secure Hash Algorithm (SHA-256)) to produce an output of fixed length (e.g., hash value 206). In implementations, any hashing algorithm may be used, such as a cryptographically secure hashing algorithm. In some implementations, the same hashing algorithm may be used to determine every hash value 206 of the entries 202 of the ledger 200.

In some implementations, every hash value 206 may be determined using the same fields of transaction data 204 as inputs to the hashing algorithm (apart from the genesis entry since a hash value of a previous entry is not available).

For purposes of illustration, rather than limitation, transactions A-C show the transactions of the same virtual game item 201A. In may be noted that in some implementations, the ledger 200 may link the transactions of the same virtual game item separately from transactions of other virtual game items. For example, the transactions of virtual game item 201A may be linked chronologically without other intervening transactions of other virtual game items (e.g., every virtual game item has its own unique chain). In other implementations, the entries of the ledger 200 may record the transactions of multiple virtual game items in chronological order in a single chain. For example, the transactions of multiple virtual game items (e.g., virtual game items 201A-N) are linked in chronological order to form a single chain of entries for ledger 200. In both cases, the hash value (e.g., hash value 206) of an entry 202 uses the hash value from the previous transaction (e.g., immediately preceding in chronological order) in the ledger 200 to generate the new hash value for a particular entry.

FIG. 3 is a flow diagram illustrating method 300 for creating a secure chain of custody using a ledger and for using the ledger in a collaboration platform, in accordance with implementations of the disclosure. Method 300 may be performed by processing logic that includes hardware (e.g., circuitry, dedicated logic, programmable logic, microcode), software (e.g., instructions run on a processing device to perform hardware simulation), or a combination thereof. In some implementations, chain of custody module 140 executing at collaboration platform 120, client device 110A, client device 110B, server 130 or combination thereof may perform some or all the operations. Elements of FIGS. 1 and 2 may be used to help illustrated method 300. It may be noted that the in some implementations, method 300 may include the same, different, fewer, or greater operations performed in any order.

Method 300 begins at block 305 where processing logic performing method 300 performs one or more transactions of a virtual game item that transfers the virtual game item between user accounts of the collaboration platform 120. At block 310, processing logic generates one or more entries 202 in a ledger 200 to record the one or more transactions of the virtual game item. Each entry 202 may correspond to a particular transaction of the virtual game item. In implementations, the entries 202 of the ledger 200 are linked to a preceding entry using one or more hash values. For example, with respect to transaction B of FIG. 2, entry 202B is linked to the preceding entry 202A by using hash value “fe2bb01” as input to create another hash value 206B that is specific to entry 202B.

In implementations, processing logic may perform a first transaction (e.g., transaction A) of the transactions of the virtual game item that transfers the virtual game item from the first user account (e.g., user account A) to a second user account (e.g., user account B) of the user accounts of a gaming platform. Processing logic may generate a first entry (e.g., entry 202A) of the entries in the ledger 200 that records the first transaction of the virtual game item (e.g., virtual game item 201A). The first entry may include first transaction data (e.g., transaction data 204A) indicative of the first transaction of the virtual game item from the first user account to the second user account and a first hash value (e.g., hash value 206A) of the first transaction data.

Subsequent to generating the first entry of the ledger 200, processing logic may perform a second transaction (e.g., transaction B) of the transactions of the virtual game item that transfers the virtual game item from the second user account (e.g., user account B) to a third user account (user account C) of the gaming platform. Processing logic may generate a second entry (e.g., entry 202B) of the entries in the ledger 200 that records the second transaction (e.g., transaction B) of the virtual game item. The second entry may include second transaction data (e.g., transaction data 204B) indicative of the second transaction of the virtual game item from the second user account to the third user account, the first hash value (e.g., value of the field hash value 220B) of the first transaction data, and a second hash value (e.g., hash value 206B) of the second transaction data and the first hash value. In some implementations, the virtual game item may only exist or be transferred within the collaboration platform 120, and cannot be transferred outside of the collaboration platform 120.

At block 315, processing logic may receive a claim (e.g., user request) from a first user account (e.g., user account A) of the user accounts to dispute a first transaction (e.g., transaction A) of the transactions. For example, collaboration platform 120 may be a low-trust environment. For example, if one party involved in a transaction does not deliver on a promise to deliver, the injured party may dispute the transaction and ask for damages (e.g., ask for the return of the transferred virtual game item). In implementations, a user may submit a claim (e.g., email or submit an online form) to collaboration platform 120 that disputes the transaction with the offending party (e.g., the user account receiving the virtual game item in the disputed transaction) or requests reimbursement.

At block 320, processing logic performs a validation operation to determine whether the claim disputing the first transaction (e.g., transaction A) is valid based on transaction data (transaction data 204A) of the ledger 200 associated with the virtual game item 201A. A validation operation may refer to one or more operations to determine the legitimacy of the claim disputing a transaction of a virtual game item.

In implementations, a validation operation may include one or more operations. In some implementations, a validation operation may determine whether the user account (e.g., injured party) actually had possession of the virtual game item in dispute at the time of the disputed transaction (e.g., the user account disputing the transaction may have never owned the virtual game item and be submitting a fraudulent claim). In some implementations, the validation operation may verify the disputed transaction of the virtual game item (e.g., that the transaction of the virtual game item actually occurred). In some implementations, the validation operation may further verify whether the disputed transaction was with the claimed offending party (e.g., user account B).

In some implementations, the validation operation may identify a current location of the virtual game item. The ledger 200 may be used to find the current location of the virtual game item, as the last entry of the ledger 200 may identify the current location (e.g., user account of the last transferee). For example, subsequent to the disputed transaction, the virtual game item may be transferred to one or more additional user accounts. In some cases, the multiple transfers of a virtual game item may be an attempt to obfuscate, “fence”, or “launder” the particular virtual game item. The validation operation may trace or follow the virtual game item through each successive transaction and determine the final transaction (e.g., the last entry of the ledger for the particular virtual game item). In some implementations, if any of the validation operations fail or identify that the claim is not valid, the virtual game item may not be “returned” to the user account disputing the transactions (e.g., the account restore operation in not performed).

In some implementations, the validation operation may include validating one or more of the entries 202 in the ledger 200 for the particular virtual game item 201A. For example, to validate entry 202B (i.e., transaction B) of ledger 200, a message may be created that includes the transaction data 204B (e.g., hash value 206A in hash value field 220A, timestamp 208B, transferor ID 210B, transferee ID 212B, and game item ID 214A) of entry 202B. In some implementations, the message may combine the transaction data 204B. For example, the combination of transaction data 204B may include concatenating the transaction data 204B in a binary form. In another example, the combination of transaction data 204B may include converting the transaction data 204B into hexadecimal strings and concatenating the hexadecimal strings. In implementations, the validation operation may further include applying the hashing function on the message data to compute a hash value. The hash function may be the same hash function used to compute the original hash value (e.g., hash value 206B) of the entry 202B. In implementations, the computed hash value is compared to the stored hash value (e.g., hash value 206B) for the entry 202B. If the computed hash value matches the stored hash value 206B, entry 202B is valid. If the computed hash value does not match the stored hash value 206B, entry 202B in not valid. In some implementations, the validation operation to validate entries 202 may be applied from the genesis entry (e.g., entry 202A) (or from the disputed transaction) and work forwards (e.g., transaction B, followed by transaction C, etc.) to ensure that all the entries (e.g., entry 202B, 202C) are valid. If any of the entries are invalid, the validation operation fails and the account restore operation is not performed. If all the entries are valid, the validation operation succeeds and the account restore operation is performed.

If the claim is determined to be valid using the validation operations, processing logic moves to block 325 and performs an account restore operation based on the ledger 200. An account restore operation may restore the user account disputing the transaction to a state that appears as if the disputed transaction had never occurred. Additionally, the account restore operation may restore any other user accounts to a state that appears as if the disputed transaction had never occurred. For example, if any intermediary user accounts exchanged a virtual game item for the disputed virtual game item, the intermediary user accounts may be restored to a state as if the transaction had never occurred (e.g., return of the exchanged virtual game item). In some implementations, processing logic executing the account restore operation retrieves the virtual game item from another user account identified as a last entry in the ledger and restores the virtual game item to the first user account.

It may be noted that at either block 320 (validation operation) or block 325 (account restore operation) processing logic may suspend any further transactions involving the disputed virtual game item until a resolution of the claim by the injured party.

At block 330, processing logic updates the ledger 200 to account for the one or more account restore operations. In some implementations, updating the ledger 200 includes generating one or more additional entries in the ledger based on the one or more account restore operations. One or more additional entries are generated to record the one or more additional transactions to transfer the virtual game item from the user account identified as the last entry in the ledger to the first user account. For example, the ledger using hash values, as described herein, may have existing entries that cannot be altered or changed. To account for the account restore operations, the ledger is updated to add additional entries that show the additional transactions of the virtual game item, rather than altering or erasing existing entries. The ledger may be updated to add additional entries to account for any additional user accounts affected by the account restore operations.

At block 335, processing logic performs a punitive operation on the second user account. In some implementations, a punitive operation may include suspending a user account, terminating a user account, or eliminating or suspending a particular function of the user account (e.g., eliminating or suspending the ability to transfer the disputed virtual game item or any virtual game items) while maintaining the ability to execute other functions of the user account (e.g., ability to play games, etc.).

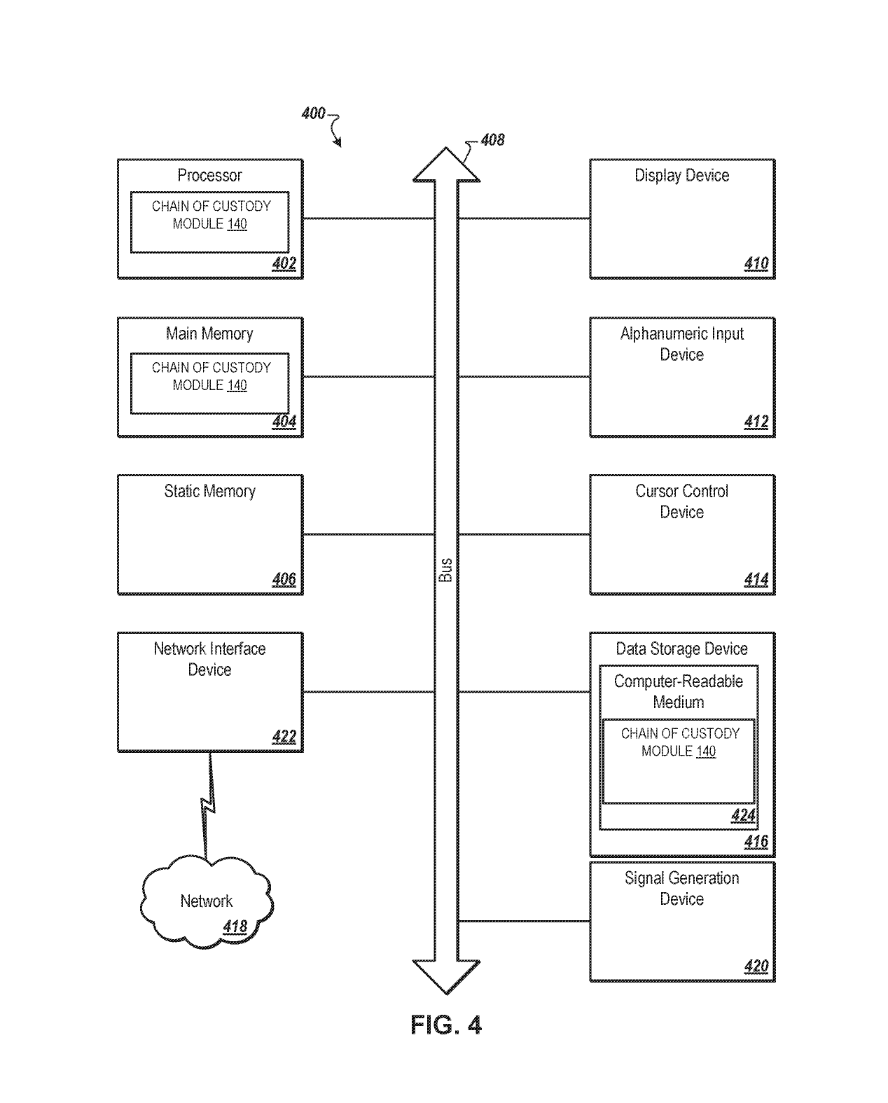

FIG. 4 is a block diagram illustrating an exemplary computer system 400, in accordance with implementations. The computer system 400 executes one or more sets of instructions that cause the machine to perform any one or more of the methodologies discussed herein. Set of instructions, instructions, and the like may refer to instructions that, when executed computer system 400, cause computer system 400 to perform one or more operations of chain of custody module 140. The machine may operate in the capacity of a server or a client device in client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage device 416, which communicate with each other via a bus 408.

The processing device 402 represents one or more general-purpose processing devices such as a microprocessor, central processing unit, or the like. More particularly, the processing device 402 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 402 may also be one or more special-purpose processing devices such as an application specific integrated circuit (ASIC), a field programmable gate array (FPGA), a digital signal processor (DSP), network processor, or the like. The processing device 402 is configured to execute instructions of the system architecture 100 and the chain of custody module 140 for performing the operations discussed herein.

The computer system 400 may further include a network interface device 422 that provides communication with other machines over a network 418, such as a local area network (LAN), an intranet, an extranet, or the Internet. The computer system 400 also may include a display device 410 (e.g., a liquid crystal display (LCD) or a cathode ray tube (CRT)), an alphanumeric input device 412 (e.g., a keyboard), a cursor control device 414 (e.g., a mouse), and a signal generation device 420 (e.g., a speaker).

The data storage device 416 may include a non-transitory computer-readable storage medium 424 on which is stored the sets of instructions of the system architecture 100 and chain of custody module 140 embodying any one or more of the methodologies or functions described herein. The sets of instructions of the system architecture 100 and chain of custody module 140 may also reside, completely or at least partially, within the main memory 404 and/or within the processing device 402 during execution thereof by the computer system 400, the main memory 404 and the processing device 402 also constituting computer-readable storage media. The sets of instructions may further be transmitted or received over the network 418 via the network interface device 422.

While the example of the computer-readable storage medium 424 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that cause the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operation s leading to a desired result. The sequence of operations is those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “performing,” “generating,” “receiving,” “determining,” “verifying,” “identifying,” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. The terms “first,” “second,” “third,” “fourth,” etc. as used herein are meant as labels to distinguish among different elements and may not necessarily have an ordinal meaning according to their numerical designation.

It is to be understood that the above description is intended to be illustrative, and not restrictive. Other implementations will be apparent to those of skill in the art upon reading and understanding the above description. The scope of the disclosure may, therefore, be determined with reference to the appended claims, along with the full scope of equivalents to which such claims are entitled.

In additional implementations, one or more processing devices for performing the operations of the above described implementations are disclosed. Additionally, in implementations of the disclosure, a non-transitory computer-readable storage medium stores instructions for performing the operations of the described implementations. Also in other implementations, systems for performing the operations of the described implementations are also disclosed.

1. A method, comprising:
performing, by a processing device, a plurality of transactions of a virtual game item that transfer the virtual game item between a plurality of user accounts of a gaming platform, wherein each of the plurality of transactions is linked to a corresponding entry in a ledger among a plurality of entries, and wherein each entry in the ledger includes a secure electronic record comprising an identifier of the virtual game item, a transferor ID, a transferee ID, a timestamp of the transaction associated with the entry, and a hash value that uniquely identifies the entry, wherein each identifier of the virtual game item uniquely identifies the virtual game item within the gaming platform;
generating, by the processing device the plurality of entries in the ledger to record the transactions of the virtual game item, wherein the entries are linked to a preceding entry using one or more hash values, wherein the virtual game item is available for use by a particular user account in a virtual gaming environment hosted by the gaming platform while the virtual game item is identified as being owned by the particular user account in the ledger, wherein the virtual game item is owned by the particular user account when at least one of:
a current time at which item ownership is determined is greater than or equal to a first timestamp associated with a most recent entry that identifies the particular user account as a transferee and less than a second timestamp associated with a second entry, subsequent to the first entry, that identifies the particular user account as a transferor, or
the current time at which item ownership is determined is greater than or equal to a first timestamp associated with a most recent entry that identifies the particular user account as a transferee and the ledger does not include the second entry;
receiving, at the processing device, a claim from a first user account of the plurality of user accounts to dispute a first transaction of the plurality of transactions; and
responsive to the claim, performing, by the processing device, an account restore operation based on the ledger that retrieves the virtual game item from another user account identified as a last entry in the ledger and restores the virtual game item to the first user account.

2. The method of claim 1, wherein performing the transactions of the virtual game item that transfer the virtual game item between the user accounts of the gaming platform comprises:
performing a first transaction of the transactions of the virtual game item that transfers the virtual game item from the first user account to a second user account of the user accounts of the gaming platform;
performing a second transaction of the transactions of the virtual game item that transfers the virtual game item from the second user account to a third user account of the gaming platform;
wherein generating the entries in the ledger to record the transactions of the virtual game item comprises:
generating a first entry of the entries in the ledger that records the first transaction of the virtual game item, wherein the first entry comprises first transaction data indicative of the first transaction of the virtual game item from the first user account to the second user account and a first hash value of the first transaction data; and
generating a second entry of the entries in the ledger that records the second transaction of the virtual game item, wherein the second entry comprises second transaction data indicative of the second transaction of the virtual game item from the second user account to the third user account, the first hash value of the first transaction data, and a second hash value of the second transaction data and the first hash value.

3. The method of claim 2, wherein the first transaction data comprises a unique identifier that identifies the virtual game item.

4. The method of claim 2, wherein the first transaction data comprises a first user account identifier, a second user account identifier, and a timestamp.

5. The method of claim 1, wherein the virtual game item is a user-generated virtual item.

6. The method of claim 1, further comprising:
responsive to the claim from the first user account to dispute the first transaction, performing a validation operation to determine whether the first transaction is valid based on transaction data of the ledger associated with the virtual game item.

7. The method of claim 6, wherein performing the validation operation to determine whether the first transaction is valid based on the transaction data of the ledger associated with the virtual game item comprises:
determining whether the virtual game item was associated with the first user account at a time of the first transaction;
responsive to determining that the virtual game item was associated with the first user account at the time of the first transaction, verifying a transaction of the virtual game item from a first user account;
verifying that the transaction of the virtual game item transferred the virtual game item to a second user account; and
identifying a current location of the virtual game item identified in the last entry of the ledger.

8. The method of claim 1, further comprising:
generating one or more additional entries in the ledger based on the account restore operation, wherein the one or more additional entries to record one or more additional transactions to transfer the virtual game item from the user account identified as the last entry in the ledger to the first user account.

9. The method of claim 1, wherein the first transaction transfers the virtual game item from the first user account to a second user account, the method further comprising:
responsive to performing the account restore operation, performing a punitive operation on the second user account.

10. A system, comprising:
a memory; and
a processing device, coupled to the memory, the processing device to:
perform a plurality of transactions of a virtual game item that transfer the virtual game item between a plurality of user accounts of a gaming platform, wherein each of the plurality of transactions is linked to a corresponding entry in a ledger among a plurality of entries, and wherein each entry in the ledger includes a secure electronic record comprising an identifier of the virtual game item, a transferor ID, a transferee ID, a timestamp of the transaction associated with the entry, and a hash value that uniquely identifies the entry, wherein each identifier of the virtual game item uniquely identifies the virtual game item within the gaming platform;
generate the plurality of entries in the ledger to record the transactions of the virtual game item, wherein the entries are linked to a preceding entry using one or more hash values, wherein the virtual game item is available for use by a particular user account in a virtual gaming environment hosted by the gaming platform while the virtual game item is identified as being owned by the particular user account in the ledger, wherein the virtual game item is owned by the particular user account when at least one of:
a current time at which the item ownership is determined is greater than or equal to a first timestamp associated with a most recent entry that identifies the particular user account as a transferee and less than a second timestamp associated with a second entry, subsequent to the first entry, that identifies the particular user account as a transferor, or
the current time at which the item ownership is determined is greater than or equal to a first timestamp associated with a most recent entry that identifies the particular user account as a transferee and the ledger does not include the second entry;
receive a claim from a first user account of the plurality of user accounts to dispute a first transaction of the transactions; and
responsive to the claim, perform an account restore operation based on the ledger that retrieves the virtual game item from another user account identified as a last entry in the ledger and restores the virtual game item to the first user account.

11. The system of claim 10, wherein to perform the transactions of the virtual game item that transfer the virtual game item between the user accounts of the gaming platform, the processing device to:
perform a first transaction of the transactions of the virtual game item that transfers the virtual game item from the first user account to a second user account of the user accounts of the gaming platform;
perform a second transaction of the transactions of the virtual game item that transfers the virtual game item from the second user account to a third user account of the gaming platform;
wherein to generate the entries in the ledger to record the transactions of the virtual game item, the processing device to:
generate a first entry of the entries in the ledger that records the first transaction of the virtual game item, wherein the first entry comprises first transaction data indicative of the first transaction of the virtual game item from the first user account to the second user account and a first hash value of the first transaction data; and
generate a second entry of the entries in the ledger that records the second transaction of the virtual game item, wherein the second entry comprises second transaction data indicative of the second transaction of the virtual game item from the second user account to the third user account, the first hash value of the first transaction data, and a second hash value of the second transaction data and the first hash value.

12. The system of claim 10, the processing device further to:
responsive to the claim from the first user account to dispute the first transaction, perform a validation operation to determine whether the first transaction is valid based on transaction data of the ledger associated with the virtual game item.

13. The system of claim 12, wherein to perform the validation operation to determine whether the first transaction is valid based on the transaction data of the ledger associated with the virtual game item, the processing device to:
determine whether the virtual game item was associated with the first user account at a time of the first transaction;
responsive to determining that the virtual game item was associated with the first user account at the time of the first transaction, verify a transaction of the virtual game item from the first user account;
verify that the transaction of the virtual game item transferred the virtual game item to a second user account; and
identify a current location of the virtual game item identified in the last entry of the ledger.

14. The system of claim 10, the processing device further to:
generate one or more additional entries in the ledger based on the account restore operation, wherein the one or more additional entries to record one or more additional transactions to transfer the virtual game item from the user account identified as the last entry in the ledger to the first user account.

15. The system of claim 10, wherein the first transaction transfers the virtual game item from the first user account to a second user account, the processing device further to:
responsive to performing the account restore operation, perform a punitive operation on the second user account.

16. A non-transitory computer readable medium comprising instruction that, responsive to execution by a processing device, cause the processing device to:
perform a plurality of transactions of a virtual game item that transfer the virtual game item between a plurality of user accounts of a gaming platform, wherein each of the plurality of transactions is linked to a corresponding entry in a ledger among a plurality of entries, and wherein each entry in the ledger includes a secure electronic record comprising an identifier of the virtual game item, a transferor ID, a transferee ID, a timestamp of the transaction associated with the entry, and a hash value that uniquely identifies the entry, wherein each identifier of the virtual game item uniquely identifies the virtual game item within the gaming platform;
generate the plurality of entries in the ledger to record the transactions of the virtual game item, wherein the entries are linked to a preceding entry using one or more hash values, wherein the virtual game item is available for use by a particular user account in a virtual gaming environment hosted by the gaming platform while the virtual game item is identified as being owned by the particular user account in the ledger, wherein the virtual game item is owned by the particular user account when at least one of:
a current time at which the item ownership is determined is greater than or equal to a first timestamp associated with a most recent entry that identifies the particular user account as a transferee and less than a second timestamp associated with a second entry, subsequent to the first entry, that identifies the particular user account as a transferor, or
the current time at which the item ownership is determined is greater than or equal to a first timestamp associated with a most recent entry that identifies the particular user account as a transferee and the ledger does not include the second entry;
receive a claim from a first user account of the plurality of user accounts to dispute a first transaction of the transactions; and
responsive to the claim, perform an account restore operation based on the ledger that retrieves the virtual game item from another user account identified as a last entry in the ledger and restores the virtual game item to the first user account.

17. The non-transitory computer readable medium of claim 16, wherein to perform the transactions of the virtual game item that transfer the virtual game item between the user accounts of the gaming platform, the processing device to:
perform a first transaction of the transactions of the virtual game item that transfers the virtual game item from the first user account to a second user account of the user accounts of the gaming platform;
perform a second transaction of the transactions of the virtual game item that transfers the virtual game item from the second user account to a third user account of the gaming platform;
wherein to generate the entries in the ledger to record the transactions of the virtual game item, the processing device to:
generate a first entry of the entries in the ledger that records the first transaction of the virtual game item, wherein the first entry comprises first transaction data indicative of the first transaction of the virtual game item from the first user account to the second user account and a first hash value of the first transaction data; and
generate a second entry of the entries in the ledger that records the second transaction of the virtual game item, wherein the second entry comprises second transaction data indicative of the second transaction of the virtual game item from the second user account to the third user account, the first hash value of the first transaction data, and a second hash value of the second transaction data and the first hash value.

18. The non-transitory computer readable medium of claim 16, the processing device further to:
responsive to the claim from the first user account to dispute the first transaction, perform a validation operation to determine whether the first transaction is valid based on transaction data of the ledger associated with the virtual game item.

19. The non-transitory computer readable medium of claim 16, the processing device further to:
generate one or more additional entries in the ledger based on the account restore operation, wherein the one or more additional entries to record one or more additional transactions to transfer the virtual game item from the user account identified as the last entry in the ledger to the first user account.

20. The non-transitory computer readable medium of claim 16, wherein the first transaction transfers the virtual game item from the first user account to a second user account, the processing device further to:
responsive to performing the account restore operation, perform a punitive operation on the second user account.
